(19) United States
(12) Patent Application Publication
(10) Pub. No.: US 2016/0263415 A1
(43) Pub. Date: Sep. 15, 2016

(54) MAGNETIC CONTROL METHOD FOR EXERCISE EQUIPMENT

(71) Applicants: Chao-Chuan Chen, Taichung City (TW); Hsi-Chieh Cheng, Nantou Hsien (TW)

(72) Inventors: Chao-Chuan Chen, Taichung City (TW); Hsi-Chieh Cheng, Nantou Hsien (TW)

(21) Appl. No.: 14/645,433

(22) Filed: Mar. 12, 2015

(51) Int. Cl. A63B 21/005; H02K 49/04

(52) U.S. Cl. CPC A63B 21/0051; H02K 49/043; A63B 21/0056

(57) ABSTRACT

A magnetic control method for controlling the magnetic damping force to the flywheel of the exercise equipment includes a magnetic control system having a control member and a magnetic array set. At least two track rails are installed outside of flywheel and parallel to the axle of flywheel. The magnetic array set is installed on the at least two track rails and has the consistent gap to flywheel. The control member drives and controls the magnetic array set to move co-axially to the axle and parallelly to the cylindrical surface of flywheel, along the at least two track rails to adjust the magnetic damping force to the flywheel. The overlapped area between the magnetic array and the cylindrical surface of flywheel is varied by control member to move the magnetic array set. So as the relationship between the magnetic damping force and the moving distance of the magnetic array set is linear. Thus the control member can be linear setting to build.

### BACKGROUND OF THE INVENTION

1. Fields of the Invention

The present invention relates to a magnetic control method and the construction for exercise equipment. The magnetic control method is based on the consistent gap between the magnetic array and the flywheel, and the magnetic array coaxially and parallelly moves along the rails relative to the outside cylindrical face of flywheel. The magnetic resistance has a linear relationship with the distance of the movement of the magnetic array. Thus a better control is obtained and the construction cost is saved.

2. Descriptions of Related Art

For exercise equipment generally the magnetic resistance is provided by a magnetic array set 10 pivoted near a flywheel set 20 as shown in FIG. 1, to control the gap between the magnetic array and the flywheel to generate different damping force. But the relationship between the magnetic strength and the gap is not linear as shown in FIG. 2. Some non-linear adjustments are needed to make in the distance control system of magnetic array with flywheel. Then the tension control can be linear to adjust by user. For this kind of cylindrical and pivoted magnetic system, A safety stop might be needed to install to prevent the magnetic array to touch with flywheel because the strong attraction force at the closest position.

Also there are some disk types of eddy brake for exercise equipment. While the axial run-out is difficult for quality control in mass production of large disks. The axial run-out also causes potential hitting problem and unstable of the magnetic control system.

### SUMMARY OF THE INVENTION

The present invention intends to provide a stable and linear magnetic control system at the consistent gap based on outside track rails on supporting frame of flywheel and magnetic array. The magnetic array is co-axially and parallelly moved and adjusted by a driving system. In this way the moving distance of magnetic array and the working force are linear relationship. Thus the driving system can be general and linear adjusting construction or device.

In order to achieve the purpose of the present invention, the present invention relates to a magnetic control method for exercise equipment. The method comprises a magnetic control system having a control member and a magnetic array set. At least two track rails outside of cylindrical surface of flywheel are installed on supporting frame, and the magnetic array set is installed on the at least two outside track rails. The control member drives and controls the magnetic array set outside of the cylindrical surface of flywheel to move co-axially and parallelly along the at least two track rails to adjust the magnetic damping force to the flywheel. By control member to move the magnet array from the far side to the close side, the overlapped area between the magnetic array and the cylindrical surface of flywheel is varied. So as the magnetic damping force is varied from low to high, and has a linear relationship with the distance that the magnetic array moves into the cylindrical surface of flywheel.

Furthermore, the magnetic array set has track bushings. The number of the tracking bushings is the same as that of the at least two track rails. The tracking bushings guide the magnetic array to move on track rails. The track rails guide the gap of magnetic array to the cylindrical surface of flywheel.

Furthermore, each of the at least two track rails has a resilient member be installed. The resilient members can push the magnetic array set to rebound if control member is some like pulling wire system to pull the magnetic array set. The control member like pulling wire system can pull the magnetic array set to move in, and the resilient member can push the magnetic array set to move out of the cylindrical surface of flywheel. Thus the magnetic array set can move forth and back, and be adjust by the control member.

Furthermore, the control member is a pulling wire system, which is driven manually by hand or automatically by a motorized device. Meanwhile at least one transferring pulley can be installed for changing the direction of the pulling wire. Thus the position of control member can be flexible.

Furthermore, the control member can be a motorized drive with a screw rod. Instead of pulling wire system the magnetic array set has a screw bushing mounted on fixed position of the magnetic array set. The screw bushing guide the magnetic array set to move on the screw rod of the motorized drive. Thus by control member the magnetic array can be adjusted to change the damping force to flywheel.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows the conventional pivoted magnetic control system;

FIG. 2 shows the relationship of the magnetic damping force with the gap between the flywheel and the magnetic array in FIG. 1;

FIG. 3 is a perspective view to show the magnetic control system of the present invention;

FIG. 4 is an exploded view of the magnetic control system of the present invention;

FIGS. 5 and 6 show the magnetic array set moves from the far side to the close side, and the overlapped area increases in FIG. 3;

FIG. 7 shows the relationship between the magnetic damping force and the moving distance of the magnetic array for the present invention;

FIG. 8 is a perspective view to show the magnetic array set is moved by a motorized wire system;

FIG. 9 is a perspective view to show the magnetic array set is moved by a screw rod of motorized device, and

FIG. 10 is an exploded view of the magnetic control system in FIG. 9.

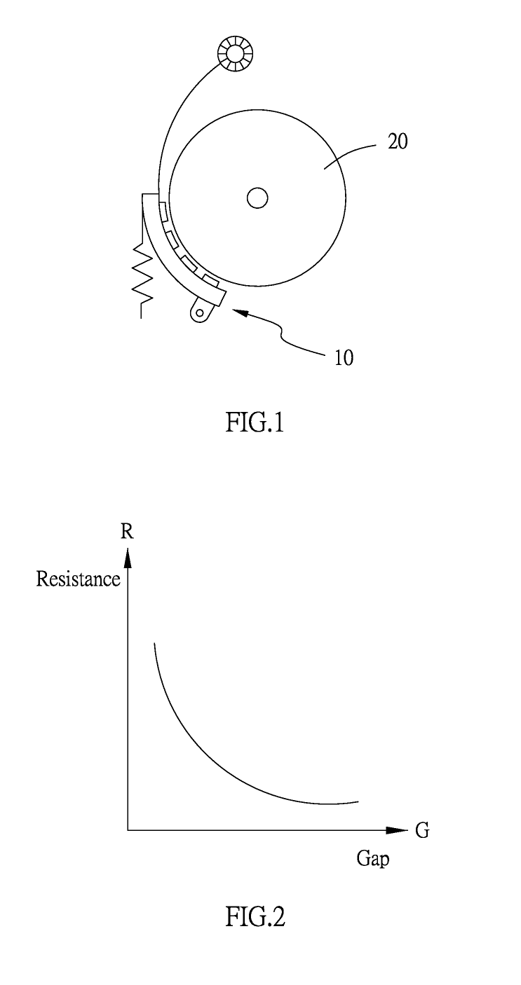

### DETAILED DESCRIPTION OF THE PREFERRED EMBODIMENT

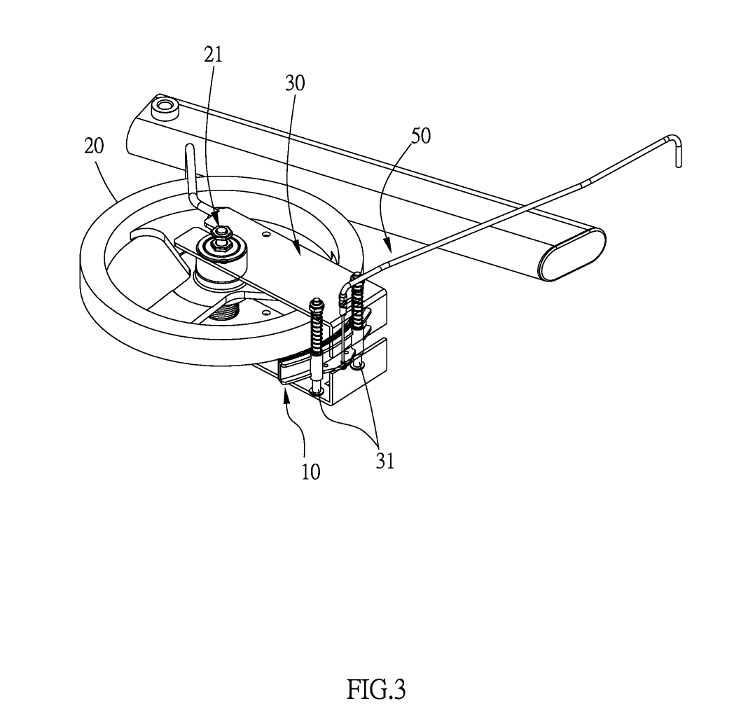

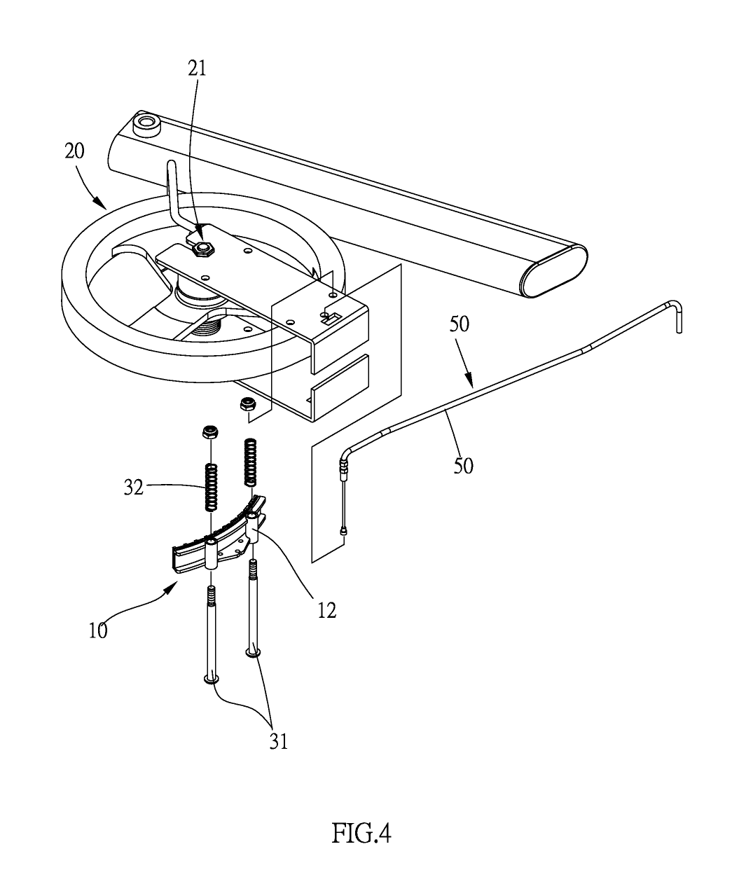

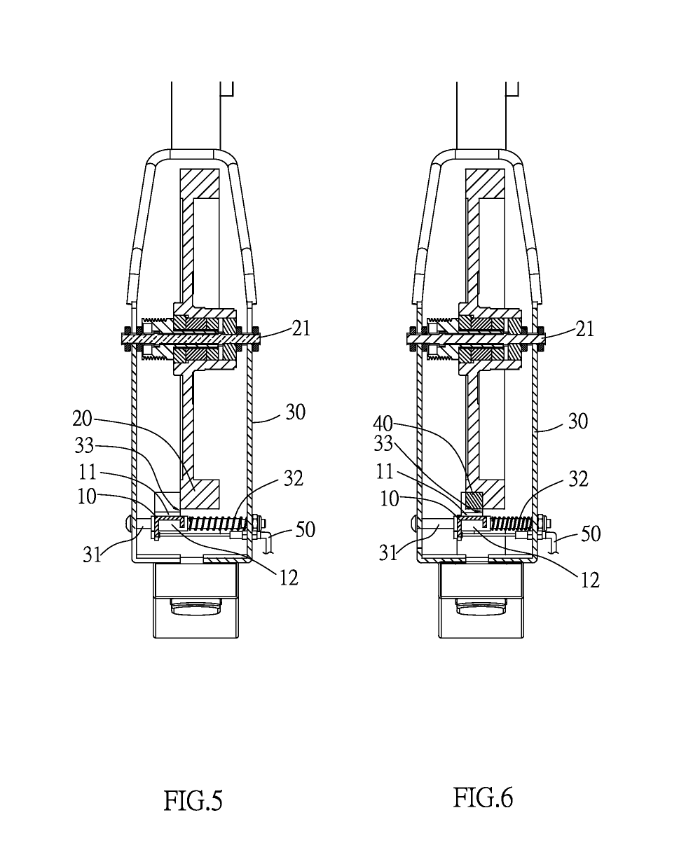

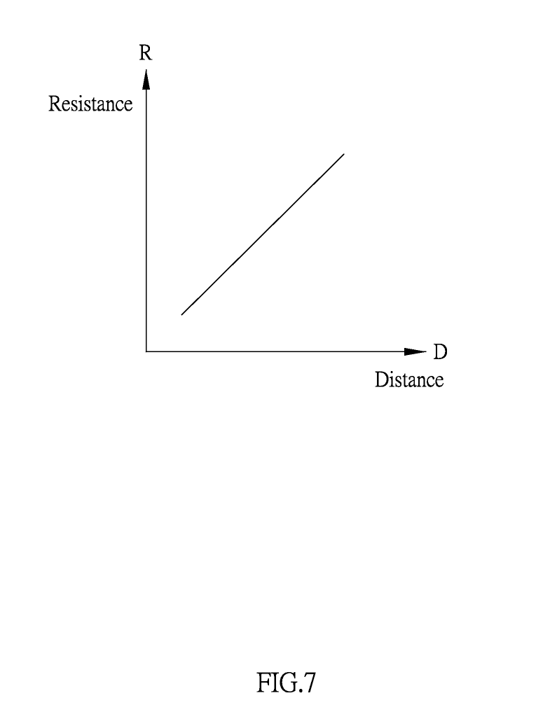

Referring to FIGS. 3 to 6, the magnetic control method of the present invention to control the magnetic damping force at the consistent gap 33 comprises a control member 50 and a magnetic array set 10. At least two track rails 31 outside of cylindrical surface of flywheel 20 and parallel to the axle 21 of flywheel 20 are installed on supporting frame 30 of exercise equipment. The track rails 31 are parallel to the axle 21 of flywheel 20 and guide the gap 33 of the magnetic array 11 of the magnetic array set 10 and flywheel 20. The magnetic array set 10 has the same number of track bushings 12 as the at least two track 31 rails to guide the movement direction, and is installed on the at least two track rails 31. The control member 50 drives and controls the magnetic array set 20 to move along the at least two track rails 31 to adjust the magnetic damping force to the flywheel 20. The control member 50 controls the magnetic array 10 to move co-axially to the axle 21 and parallelly to the cylindrical surface of flywheel 20 along the at least two track rails 31. The overlapped area 40 as shown in FIG. 6 between the magnetic array 11 of the magnetic array set 10 and the cylindrical surface of flywheel 20 is varied. When control member 50 controls the magnetic array set 10 from far side to close side as shown in FIGS. 5 and 6, the magnetic damping force is varied from low to high, and depends on the overlapped 40 area between the magnetic array 12 and the cylindrical surface of flywheel 20. The relationship between the magnetic damping force and the moving distance of the magnetic array set 10 is linear as shown in FIG. 7 when flywheel 20 rotates at a consistent speed. Thus the control member can be linear setting to control the movement of the magnetic array set 10 to generate magnetic damping force to flywheel 20. A precise and simple control system can be constructed accordingly.

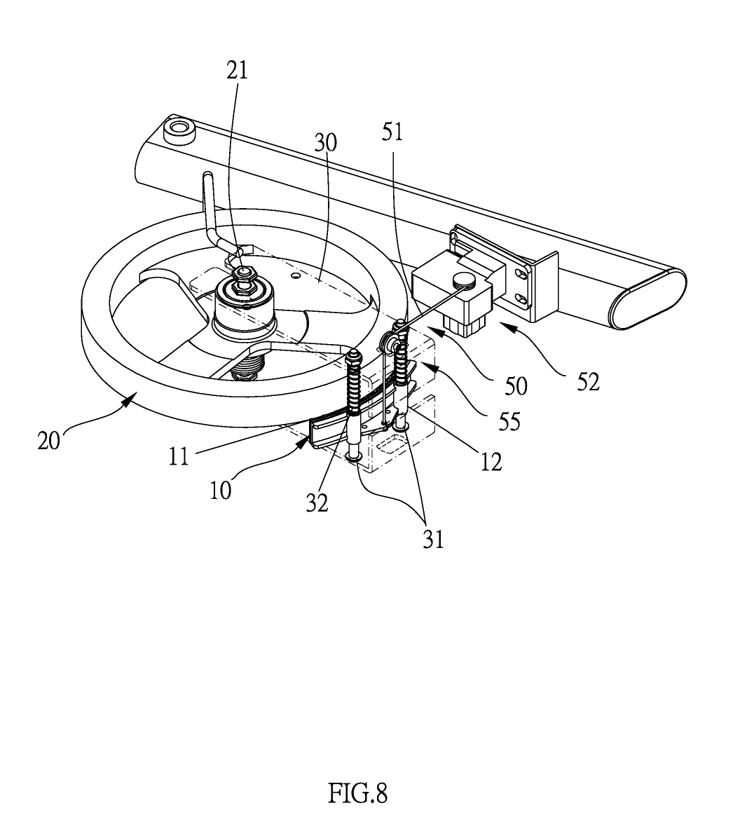

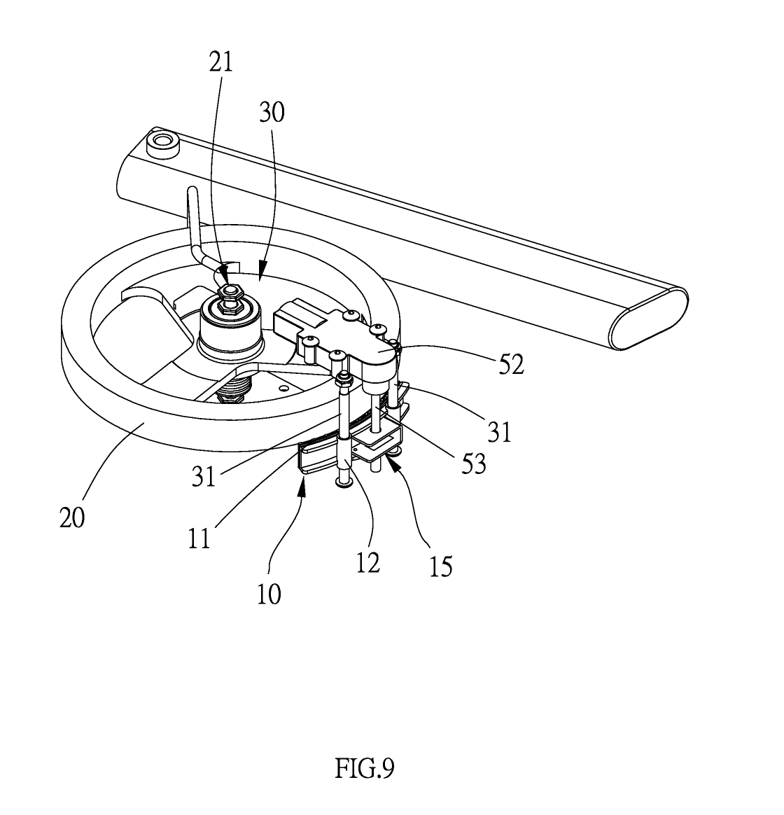

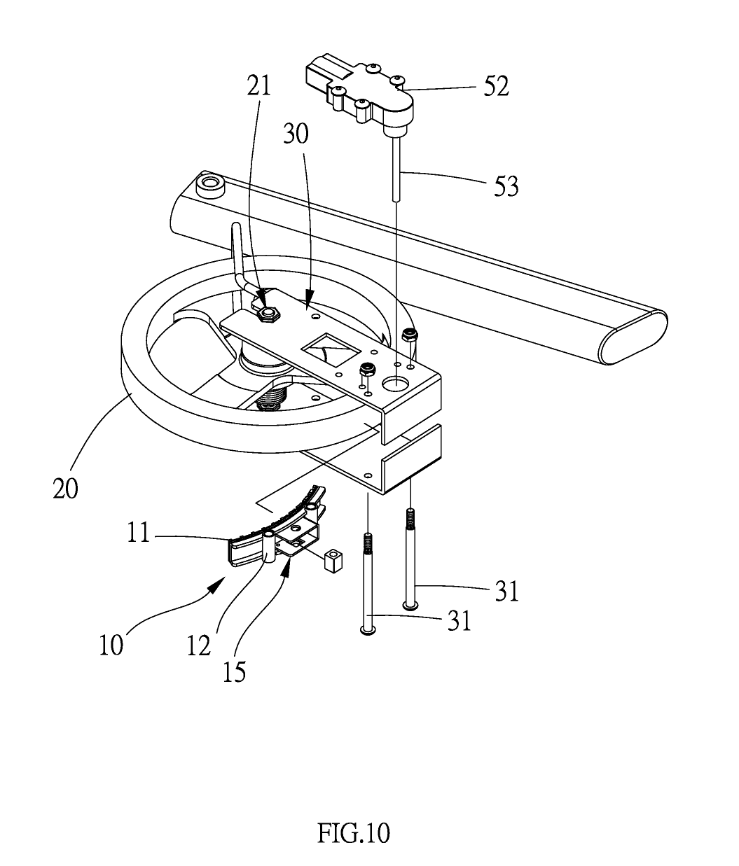

As shown in FIGS. 3 to 6, in the preferable embodiment of the present invention, the control member 50 is a puling wire system with linear setting to manually control by hand. And some similar pulling wire system can be made to automatically control by motorized device as shown on FIG. 8. Each of the at least two track rails 31 has a resilient member 32 be installed. The resilient members 32 can push back the magnetic array set 10 if the control member 50 loosened the pulling wire 51. So by the control member 50 to pull and the resilient member 32 to push, the magnetic array set 10 will move forth and back from far side to close side position along the track rails, and so on to adjust the position.

Based on the basic arrangement mentioned above, at least one transferring pulley 55 can be installed on the control member 50 as shown on FIG. 8 to change the direction of the pulling wire 51. So the installation of the control member 50 can be flexible to decide to fit in the space of exercise equipment.

Furthermore the control member 50 can be a motorized drive 52 with a screw rod 53. Instead of pulling wire system, the magnetic array set 10 has a screw bushing 15 mounted on fixing position of the magnetic array set 10. The screw bushing 15 guides the magnetic array set 10 to move on the screw rod 53. By this way the control member 50 can control the magnetic array set 10 to adjust the magnetic damping force to flywheel.

While we have shown and described the embodiment in accordance with the present invention, it should be clear to those skilled in the art that further embodiments may be made without departing from the scope of the present invention.

What is claimed is:

1. A magnetic control method for controlling the magnetic damping force to the flywheel of an exercise equipment, comprising:
a magnetic control device having a control member and a magnetic array set, and
at least two track rails installed on the supporting frame of exercise equipment and outside of cylindrical surface of flywheel, the magnetic array set installed on the at least two track rails, each of track rails parallel to the axle of flywheel, the control member driving and controlling the magnetic array set to move along the at least two track rails to adjust the magnetic damping force to the flywheel, the control member controlling the magnetic array set to move co-axially to the axle of flywheel and parallelly to the cylindrical surface of flywheel, an overlapped area between the magnetic array and the cylindrical surface of flywheel being varied by control member to move the magnetic array set to generate different magnetic damping force which has a linear relationship with the distance that the magnetic array set moves, the control method being precise and simple for exercise equipment.

2. The method as claimed in claim 1, wherein the magnetic array set has tracking bushings be installed thereof, the number of the tracking bushings is the same as that of the at least two track rails, tracking bushings guiding the magnetic array set to move along the track rails.

3. The method as claimed in claim 1, wherein each of the at least two track rails has a resilient member installed thereto, each of the resilient member has one end thereof contacting the tracking bushing corresponding thereto, the other end of each of the resilient members contacting the supporting frame of exercise equipment.

4. The method as claimed in claim 1, wherein the control member is pulled by a wire which is pulled manually by hand or automatically by a motorized device, at least one transferring pulley can be installed to change the direction of pulling wire and the location of control member.

5. The method as claimed in claim 1, wherein the control member is a motorized device with a screw rod so as to move the magnetic array set, the magnetic array set has a screw bushing, the screw bushing guiding the magnetic array set to move on the track rails.
